(19) United States
(12) Patent Application Publication
(10) Pub. No.: US 2012/0311692 A1
(43) Pub. Date: Dec. 6, 2012

(54) COMMUNICATION CONTOL APPARATUS AND PACKET FILTERING METHOD

(76) Inventors: Akihiro Ebina, Kyoto (JP); Seiji Kubo, Osaka (JP)

(21) Appl. No.: 13/318,635

(22) PCT Filed: Jun. 2, 2011
(86) PCT No.: PCT/JP2011/003097

§ 371 Date: Nov. 3, 2011

(51) Int. Cl. G06F 9/00

(52) U.S. Cl. 726/13

(57) ABSTRACT

A communication control apparatus (100) that executes one or more communication application programs includes a first control unit (206), a first memory (103), a storage unit (105) in which first condition information (405) is stored, and a network communication unit (102). The network communication unit (102) includes a receiving unit (201), a second memory (200) for storing second condition information (205), and a second control unit (210) that performs a filtering process that is a process to transfer, to the first memory (103), a packet that matches a condition registered in the second condition information (205) out of packets received by the receiving unit (201). The first control unit (206) updates the second condition information (205) using at least one of the N+1 or more conditions indicated in the first condition information (405).

### TECHNICAL FIELD

The present invention relates to a communication control apparatus and a packet filtering method for avoiding attacks from a network against a system such as a Denial of Service attack (DoS attack).

### BACKGROUND ART

Conventionally existing DoS attack disables a service and a system by transmitting large amounts of data in short time to an apparatus having a network function and thereby placing high loads on the network apparatus.

A well-known attack method in the DoS attack is transmitting a numerous number of ICMP Echo Request packets in short time, using a protocol called Internet Control Message Protocol (ICMP). Conventionally, knowledge of network has, been required to perform such a DoS attack.

However, recent years have seen a widespread use of easily available tools for the DoS attack. This makes an environment where even a user having little knowledge of network can easily perform such an attack. As a result, the user can perform not only ICMP but also various kinds of DoS attack.

There are basically two types of methods for avoiding such a DoS attack.

A first method is to find out content of the patterns of the DoS attack in advance and discard packets that match the DoS attack patterns and thereby avoid the attack. This method is used in anti-virus software for ensuring security of, for example, Personal Computers (PCs).

A second method is to selectively receive only packets which are used for communication by the apparatus. This method includes, for example, the MAC address filtering function which is provided with conventionally existing Media Access Control (MAC).

The MAC address filtering function represents a method to register, in a receiving apparatus, a unicast MAC address of another apparatus so that the receiving apparatus does not receive packets that are sent from apparatuses other than the other apparatus, thereby ensuring security of the receiving apparatus.

Furthermore, one of preceding examples of implementing firewall is, as disclosed in PTL 1, a method of registering hashed packet pattern in a table.

### CITATION LIST

### Patent Literature

[PTL 1] Japanese Unexamined Patent Application Publication No 2007-142664

### SUMMARY OF INVENTION

### Technical Problem

Here, techniques for the DoS attack are evolving day by day, and attacks using various patterns are engendered. Thus, in the method to find out patterns of the DoS attack in advance, the attack patterns need to be updated frequently.

Thus, this method is effective in use with apparatuses such as PCs whose purposes of use are not specified, for example, apparatuses that generally allow addition and deletion of communication application programs (hereinafter simply referred to as “communication programs”) depending on the purposes of use.

Meanwhile, for communication apparatuses whose services to be implemented are specified, the method to receive only the packets for use in communication allows a more effective avoidance of the DoS attack.

Examples of such communication apparatuses include home appliances such as TVs and hard disc recorders. For example, recently, there is a TV having a function to obtain rnulti-media content via the Internet and reproduce the obtained content. A TV having such a network function performs, in principle, only a program that is embedded at the time of shipment from the factory and does not perform subsequent addition or deletion of a communication program.

Therefore, in principle, a type of a packet used by the TV is limited to that identified in advance. That is, theoretically, the DoS attack can be avoided by registering only a pattern of a packet of the identified type as a condition to be passed a filter.

Furthermore, unlike PCs and the like, such an embedded apparatus generally performs packet filtering by hardware such as a Local Area Network (LAN) controller in order not to disturb main processes (for example, regarding TVs, channel selection and broadcast data decoding). This allows to avoid placing loads caused by packet filtering to the Central Processing Unit (CPU) which performs the main processes.

It is assumed here that an idea to (i) register only a pattern of a packet that is required by the apparatus in a filter and (ii) determine a packet that does not match the registered pattern is a DoS packet, is applied to the conventional packet filtering function. In this case, the number of registerable patterns is limited, while the number of patterns of the packets required by the apparatus for implementing various services tends to increase. Therefore, there is a problem that not all of the packet patterns required for packet filtering can be registered.

It is to be noted that it is possible to increase the number of the packet patterns to be registered by using hashing, for example, as the technique disclosed in the PTL 1. However, this technique does not ultimately solve the problem that not all of the necessary packet patterns can be registered.

Particularly, as described above, when packet filtering is to be implemented by hardware, an increased memory capacity of the hardware is required in order for increasing the number of the registerable patterns. However, taking into consideration, for example, manufacturing costs, to increase memory capacity is not an appropriate solution for the problem.

The present invention has been conceived in view of the aforementioned conventional problems, and has an object to provide a communication control apparatus which (i) has a packet filtering function to allow only the packet that matches the registered condition to pass and (ii) performs appropriate packet filtering without increasing the capacity of the memory for storing the condition.

### Solution to Problem

In order to solve the aforementioned problems, a communication control apparatus according to an aspect of the present invention is connected to a network and executes one or more communication application programs. The communication control apparatus includes a first control unit, a first memory for storing packets to be processed by the one or more communication application programs, a storage unit in which first condition information is stored, the first condition information indicating N+1 or more conditions (N representing art integer equal to or greater than 1) for identifying packets to be stored in the first memory, and a network communication unit configured to selectively transfer a received packet to the first memory, wherein the network communication unit includes a receiving unit that receives a packet transmitted via the network, a second memory for storing second condition information, the second condition information in which at most N conditions out of the N+1 or more conditions are registered, and a second control unit that performs a filtering process that is a process to transfer, to the first memory, a packet that matches a condition registered in the second condition information out of packets received by the receiving unit, and the first control unit updates the second condition information using at least one of the N+1 or more conditions indicated in the first condition information.

Even when not all of conditions for use in identifying packets required by the communication control apparatus, can be registered in the second condition information because of, for example, the small capacity of the second memory, this structure allows to use each of the all of the conditions for packet filtering.

More specifically, the first control unit can temporally change a combination of plural conditions stored in the second memory which is referred to by the second control unit. This allows to use all of the conditions, required for identifying packets to be transferred to the first memory, for packet filtering.

More specifically, even during the period that an update, such as an addition or a deletion, of the conditions is not performed on the first condition information (the period that the N+1 or more conditions are maintained as they are), the update of the second condition information is performed. As a result, in a predetermined period, all of the N+1 or more conditions can be used as the conditions actually used for the filtering process.

This allows to store only the packet required by the communication control apparatus in the first memory and ensure, for example, to discard packets other than the above.

Therefore, the communication control apparatus in this aspect has a packet filtering function to allow only a packet that matches the registered condition to pass, and enables an appropriate packet filtering without increasing the capacity of the memory (the second memory) in which the condition is stored.

Furthermore, in the communication control apparatus according to an aspect of the present invention, the first control unit may, when updating the second condition information, (i) read, from the first to condition information, an unregistered condition that is a condition not registered, at the time of the update, in the second condition information out of the N+1 or more conditions indicated in the first condition information, and (ii) register the unregistered condition in the second condition information by replacing the read unregistered condition with one of the conditions indicated in the second condition information.

This structure allows, when updating the second condition information for use in a comparison process in packet filtering, to (i) certainly identify a condition not registered in the second condition information at the time of the update and (ii) register the condition in the second condition information. This allows, for example, to perform a more effective packet filtering.

Furthermore, in the communication control apparatus according to an aspect of the present invention, the first control unit may repeatedly update the second condition information.

This structure allows, for example, a more effective processing of the packet required by the communication control apparatus, because the update of the second condition information is performed continuously.

Furthermore, in the communication control apparatus according to an aspect of the present invention, the first control unit may register, in the second condition information, each of the N+1 or more conditions in a predetermined order by repeatedly updating the second condition information, the N+1 or more conditions being indicated in the first condition information.

This structure allows, in the updating process of the second condition information, the first control unit to read the conditions from the first condition information in a predetermined order. Thus, for example, the updating process can be performed more efficiently. Furthermore, for example, all of the conditions for use in identifying packets required by the communication control apparatus are registered in the second condition information certainly and evenly.

Furthermore, in the communication control apparatus according to an aspect of the present invention, the first control unit may, when updating the second condition information and there is a plurality of unregistered conditions, identify an unregistered condition which has been unregistered in the second condition information for a longest period after deletion, out of the plurality of the unregistered conditions, and read the identified unregistered condition from the first condition information.

This structure allows conditions to be registered in the second condition information, in sequence, starting from the condition which has not been registered in the second condition information for the longest period. Therefore, for example, all of the conditions for use in identifying packets required by the communication control apparatus are registered in the second condition information certainly and evenly.

Furthermore, in the communication control apparatus according to an aspect of the present invention, the first condition information may further include priority information which indicates a priority of each of the conditions indicated in the first condition information, and the first control unit may, when updating the second condition information and there is a plurality of unregistered conditions, identify an unregistered condition with highest priority, out of the unregistered conditions with reference to the priority information, and read the identified unregistered condition from the first condition information.

This structure allows to certainly identify the unregistered condition with high-priority, out of the plural unregistered conditions, and to register the condition in the second condition information. Therefore, for example, packets with high-priorities as objects to be processed are processed more efficiently.

Furthermore, in the communication control apparatus according to an aspect of the present invention, the first control unit may, when updating the second condition information, identify a condition that has been registered in the second condition information earliest, out of the at most N conditions indicated in the second condition information, and replace the identified condition with the unregistered condition read from the first condition information by the control unit.

This structure allows, when updating the second condition information, to replace the unregistered condition with the condition which has been registered in the second condition information for the longest period at that time. Therefore, for example, bias is prevented from being generated in the conditions indicated in the second condition information.

Furthermore, in the communication control apparatus according to an aspect of the present invention, each of the N+1 or more conditions may correspond to one of the one or more communication application programs, and the first control unit may, when one of the one or more communication application programs is executed, update the first condition information by adding, to the first condition information, a condition which corresponds to the communication application program to be executed.

This structure allows to update the first condition information which supplies conditions to the second condition information, according to the startup status of the communication application program. Thus, the second condition information is maintained in the state in which only the condition actually required depending on the timing is registered. Therefore, for example, the efficiency of the processing related to packet filtering is improved.

Furthermore, in the communication control apparatus according to an aspect of the present invention, the first control unit may, when the execution of the communication application program is completed, delete the condition which corresponds to the communication application program from the first condition information.

This structure allows to certainly delete an unnecessary condition at the time that the condition is determined not to be required. Therefore, for example, the efficiency of the processing related to packet filtering is improved.

Furthermore, the present invention can also be implemented as a packet filtering method including a characteristic process performed by the communication control apparatus in any one of the above aspects. Furthermore, it is also possible to implement the present invention as (i) a program which causes a computer to perform each process included in the packet filtering method and (ii) a recording medium in which the program is stored. The program can also be distributed via a transmitting medium such as the Internet or a recording medium such as a DVD.

Furthermore, the present invention can also be implemented as an integrated circuit including a characteristic component of the communication control apparatus in any one of the above aspects.

### Advantageous Effects of Invention

The present invention provides a communication control apparatus which (i) has a packet filtering function to allow only a packet that matches a registered condition to pass and (ii) performs an appropriate packet filtering without increasing the capacity of the memory for storing the condition.

This allows a system having the communication control apparatus to receive only the packet required by the system, without being destroyed by the DoS attack and by utilizing the limited memory capacity.

### BRIEF DESCRIPTION OF DRAWINGS

FIG. 1 shows a configuration of main hardware of a communication control apparatus according to an embodiment of the present invention.

FIG. 2 is a block diagram showing a main functional configuration of the communication control apparatus according to the embodiment of the present invention.

FIG. 3 shows an example of data structure of a pass packet table according to the embodiment of the present invention.

FIG. 4 is a block diagram showing a main functional configuration of a control unit according to the embodiment of the present invention.

FIG. 5 shows an example of data structure of an apparatus-use packet table according to the embodiment of the present invention.

FIG. 6A is a flow chart showing a flow of a basic process performed by the communication control apparatus according to the embodiment of the present invention.

FIG. 6B is a flow chart showing a set of processes for the control unit when the control unit performs an update control, according to the embodiment of the present invention.

FIG. 7 shows an example of transition of content of each table in the case where the process flow described in FIG. 6B is performed.

FIG. 8 shows an example of correspondence of communication programs and packet patterns which are registered in the apparatus-use packet table according to the embodiment of the present invention.

FIG. 9A shows a first example of the apparatus-use packet table after an update according to the embodiment of the present invention.

FIG. 9B shows a second example of the apparatus-use packet table, after the update according to the embodiment of the present invention.

### DESCRIPTION OF EMBODIMENTS

An embodiment according to the present invention is described below with reference to diagrams.

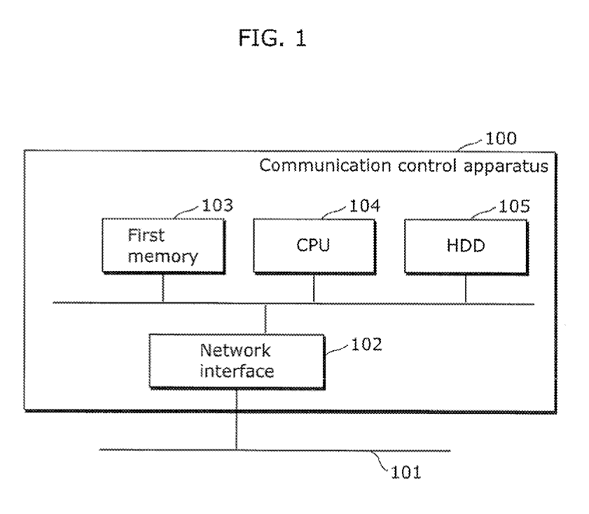

First, the structure of a communication control apparatus according to the embodiment of the present invention is described with reference to FIGS. 1 to 5.

FIG. 1 shows a configuration of main hardware of a communication control apparatus 100 according to the embodiment of the present invention.

The communication control apparatus 100 is connected with a LAN 101 which is a wired or wireless communication network, and is capable of communicating with an external apparatus via the LAN 101.

Furthermore, the communication control apparatus 100 includes a network interface 102, a first memory 103, a CPU 104, and a hard disk drive (HDD) 105.

The network interface 102 is an example of a network communication unit of the communication control apparatus according to the present invention. The network interface 102 is, in this embodiment, hardware which receives data sent from the external apparatus via the LAN 101. More specifically, the network interface 102 has memory structures such as FIFO and descriptoring, and is capable of receiving plural packets.

The first memory 103 is a memory for storing packets used by the communication control, apparatus 100 out of the packets received from the LAN 101. The packets stored in the first memory 103 are read and processed while a communication program stored in the HDD 105 is executed.

That is, the CPU 104 processes the packets stored in the first memory 103, thereby allowing the control apparatus 100 to communicate with the external apparatus.

The HDD 105 is an example of a storage unit of the communication control apparatus according to the present invention, and a storage apparatus in which an apparatus-use packet table storing patterns of packets used by the communication control apparatus 100 is stored. Furthermore, one or more communication programs executed by the communication control apparatus 100 are also stored in the HDD 105. The apparatus-use packet table is described later with reference to FIG. 5.

It is to be noted that it is sufficient for the storage unit of the communication control apparatus according to the present invention to be capable of storing information such as the apparatus-use packet table. Furthermore, the storage unit may be implemented by Electrically Erasable and Programmable Read Only Memory (EEPROM) or the like which is a non-volatile recording medium different in type from HDD.

Furthermore, the communication programs and the apparatus-use packet table may be stored in storage apparatuses separated from each other.

Furthermore, the communication control apparatus 100 is incorporated in a home appliance, a TV for example, and implemented as an apparatus which transmits and receives data via a wired or wireless network by executing a communication program.

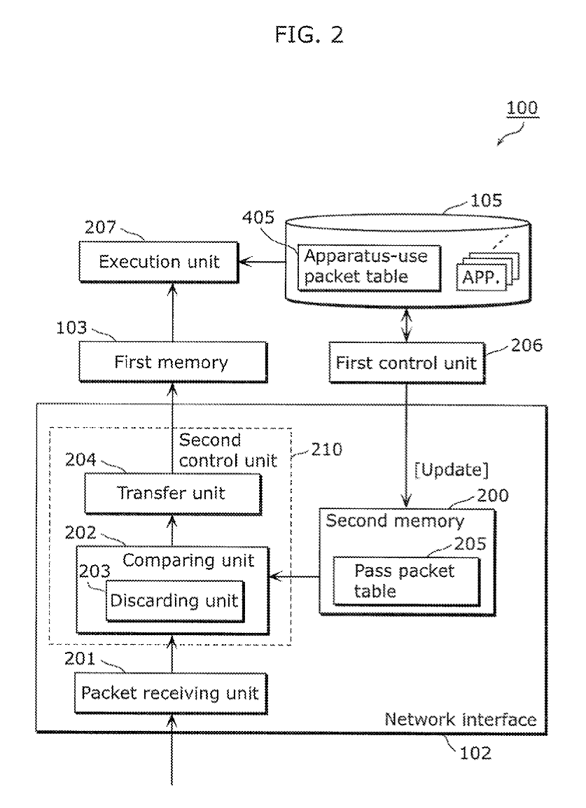

FIG. 2 is a block diagram showing the main functional configuration of the communication control apparatus 100.

The network interface 102 includes a packet receiving unit 201, a second control unit 210, and a second memory 200. Furthermore, the second control unit 210 includes a comparing unit 202 and a transfer unit 204.

The packet receiving unit 201 receives packets sent from the LAN 101.

The second control unit 210 performs a filtering process that is a process to transfer, to the first memory 103, a packet that matches a condition registered in a pass packet table 205 which is stored in the second memory 200 out of the packets received by the packet receiving unit 201. In this embodiment, the filtering process is performed through the following process performed by the comparing unit 202 and the transfer unit 204.

The comparing unit 202 compares the packet received by the packet receiving unit 201 (hereinafter also simply referred to as “a received packet”) with the condition for transferring to the first memory 103.

More specifically, the comparing unit 202 compares each of the received packets with N (N represents an integer equal to or greater than 1) packet patterns indicated in the pass packet table 205 stored in the second memory 200.

Furthermore, the comparing unit 202 includes a discarding unit 203. The discarding unit 203 discards a received packet determined not to match any one of the N packet patterns as a result of the comparison by the comparing unit 202, that is, the received packet determined not to be transferred to the first packet, before transferring the packets to the first memory 103.

It is to be noted that the second control unit 210 may determine whether or not the received packet matches any one of the N packet patterns by a process other than the comparison process. The second control unit 210 may, for example, perform the determination by assigning, to a predetermined function which includes information indicating the N packet patterns, information obtained from the received packet such as a transmission-source address and the like.

Furthermore, it is sufficient for the received packet determined not to be transferred to the first packet not to be transferred from the network interface 102 to the first memory 103, and such a received packet may be processed by a method other than discarding. For example, such a received packet may be stored in a predetermined is storing apparatus for an attack pattern analysis.

When the received packet matches any one of the N packet patterns as a result of the comparison by the comparing unit 202, the transfer unit 204 transfers the received packet to the first memory 103. Thus, the received packet is stored in the first memory 103.

The second memory 200 is, as described above, a memory for sorting the pass packet table 205.

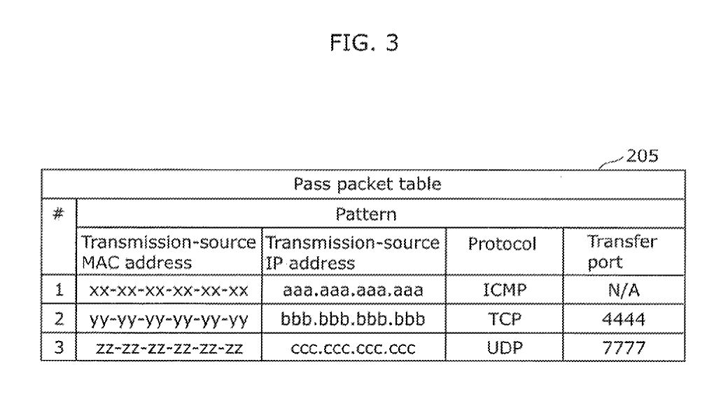

The pass packet table 205 is a table in which a condition for use in identifying packets to be received by the communication control apparatus 100 is registered. A data structure example of the pass packet table 205 is described later with reference to FIG. 3.

The first control unit 206 updates the pass packet table 205. More specifically, the first control unit 206 is capable of (i) newly registering a pattern of a packet to be transferred to the first memory 103, and (ii) deleting a pattern which is already registered.

Furthermore, a packet pattern registered in the apparatus-use packet table 405 stored in the HDD 105 is used for the update.

It is to be noted that the above updating process by the first control unit 206 and the above filtering process by the second control unit 210 are implemented, for example, by the CPU 104 to execute a control program (not shown) stored in the HDD 105.

The execution unit 207 is a processing unit which, executes the equal to or greater than one communication programs stored in the HDD to 105, and is implemented by, for example, the CPU 104. The execution unit 207 reads and processes the packets stored in the first memory 103 by executing the communication program.

Here, the second memory 200 in which the pass packet table 205 is stored is implemented by a memory in the network interface 102 configured with hardware. The maximum number of patterns registerable in such a memory included in a network interface card is approximately several tens to several hundreds, which is much less than the number of packet patterns to be received by the apparatus having the network interface card.

The communication control apparatus 100 according to this embodiment is capable of, at the network interface 102 configured with hardware as described above, recognizing that a packet not required by the communication control apparatus 100 is a packet of the DoS attack (hereinafter referred to as “an attacking packet”). The communication control apparatus 100 is also capable of discarding the packet recognized as the attacking packet before transferring the attacking packet to the first memory 103. This allows to (i) decrease the bus utilization due to data transfer and (ii) suppress the processing loads resulting from unnecessary data transfer to be placed to the CPU 104.

FIG. 3 shows an example of data structure of the pass packet table 205.

The pass packet table 205 is an example of the second condition information of the communication control apparatus according to the present invention, and is a table in which at most N conditions, out of the N+1 or more conditions indicated in the apparatus-use packet table 405, are registerable. In this embodiment, the “condition” represents a packet pattern configured with equal or greater number of attribute information of a packet.

The example shown in FIG. 3 is the pass packet table 205 configured with N=3 entries. Each entry has a “pattern” which is an item indicating a packet pattern for use in identifying a packet to be passed a filter, that is, a packet to be transferred to the first memory 103. Furthermore, each entry is assigned with an entry number.

It is to be noted that the value “3” of N above is an example for clarifying the description of the embodiment, and the value is not limited to a specific number.

The comparing unit 202 compares the received packet with information indicated in the pass packet table 205. When the received packet matches any one of the packet patterns indicated in the pass packet table 205 as a result of the comparison, the comparing unit 202 transfers the packet to the first memory 103 via the transfer unit 204. Furthermore, when the received packet does not match any one of the packet patterns indicated in the pass packet table 205, the discarding unit 203 discards the received packet.

In this embodiment, each of the packet patterns registered in the pass packet table 205 is, as shown in FIG. 3, a combination of a transmission-source MAC address indicated in an Ether frame header, a transmission-source IP address indicated in an IP header, a protocol type, and destination port information indicated in a TCP header or a UDP header.

However, information which configures the packet pattern is not limited to the header information and may be information included in other filed in the header part of the packet. In addition, the information which configures the packet pattern is not limited to the header information, and information may be obtained from data part of various protocols and registered in the pass packet table 205 as the information indicating a pattern of a packet to be passed. More specifically, information other than header information may be used for the comparison process by the comparing unit 202.

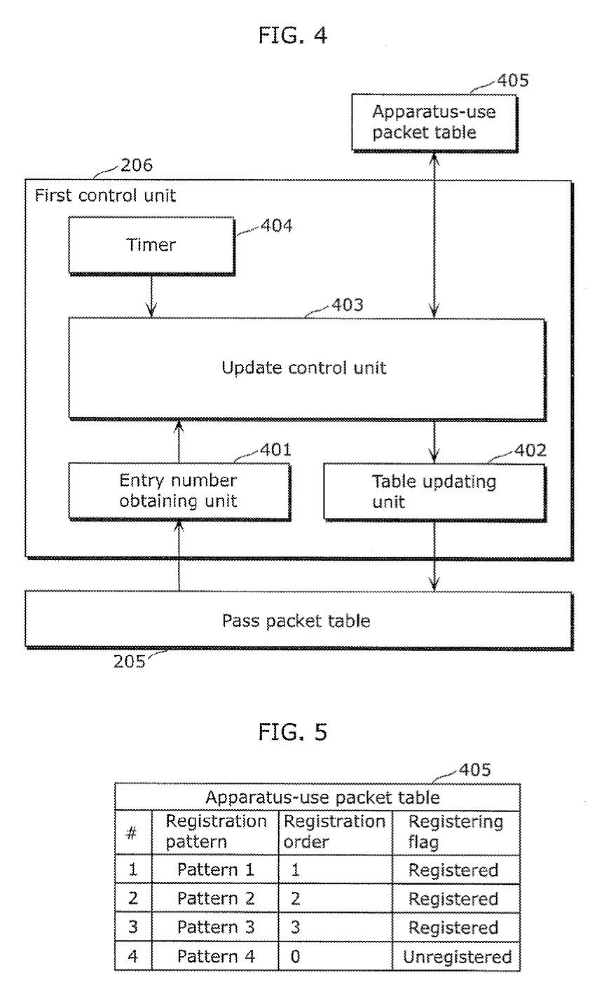

FIG. 4 is a block diagram showing the main functional configuration, of the first control unit 206.

The first control unit 206 includes an entry number obtaining unit 401, a table updating unit 402, an update control unit 403, and a timer 404.

The entry number obtaining unit 401 obtains the total number of entries of the pass packet table 205. The table updating unit 402 registers a packet pattern in the pass packet table 205 and deletes a packet pattern from the pass packet table 205.

The update control unit 403 identifies a packet pattern to be added to the pass packet table 205, out of the packet patterns in the apparatus-use packet table 405, and causes the table updating unit 402 to register the identified packet pattern in the pass packet table 205. Furthermore, the update control unit 403 identifies a packet pattern to be deleted upon the registration, and causes the table updating unit 402 to delete the identified packet pattern. More specifically, the update control unit 403 is capable of causing the table updating unit 402 to replace packet patterns.

The timer 404 notifies the timing for update to the update control unit 403.

The apparatus-use packet table 405 records all of the packet patterns used by the communication control apparatus 100. More specifically, packet patterns for use in identifying all of the packets to be transferred from the network interface 102 to the first memory 103 are recorded in the apparatus-use packet table 405.

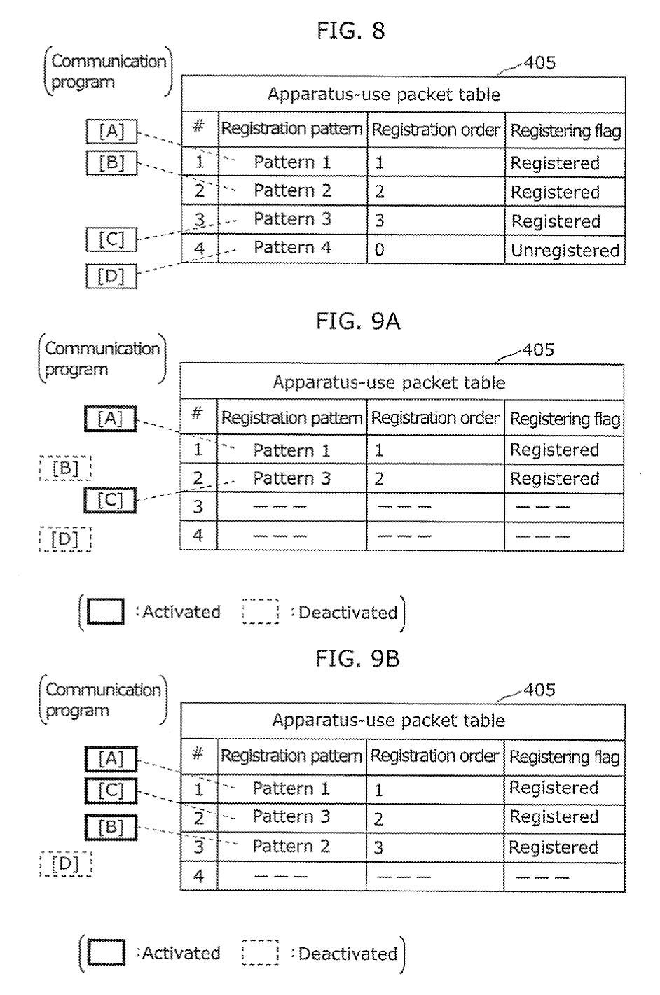

A pattern of a packet used by the communication control apparatus 100 is recorded in the apparatus-use packet table 405, for example, at the time of shipment from the factory. However, the pattern of the packet used by the apparatus may be updated, for example, depending on the startup status of the communication program of the communication control apparatus 100. Such an update of the apparatus-use packet table 405 shall be described later with reference to FIG. 8.

The timer 404 notifies the timing for update (update timing) to the update control unit 403 at a regular time interval. The timer 404 has a function to notify the update timing to the update control unit 403 at a regular time interval, for example, every 10 ms or 100 ms.

The update control unit 403, at the time of start-up of the communication program and the like, obtains the total number of entries of the pass packet table 205 via the entry number obtaining unit 401. The update control unit 403 further reads packet patterns of equivalent amount of the total number of entries from the apparatus-use packet table 405. The read packet patterns are registered in the pass packet table 205 by the table updating unit 402.

After that, for example, when the time interval of notification by the timer 404 is set to 100 ms, the timer 404 notifies the update control unit 403 to perform the update after 100 ms from the first registration. After receiving the notification, the update control unit 403 (i) obtains, from the apparatus-use packet table 405, a packet pattern not registered in the pass packet table 205, and (ii) replaces the obtained pattern with a pattern already registered in the pass packet table 205. Thus, the pass packet table 205 is updated.

As described above, even when packet patterns more than the number of entries registerable in the pass packet table 205 are required for packet filtering, the performance of the update control unit 403 makes it possible for the communication control apparatus 100 to avoid the DoS attack and receive only the packet required by the apparatus.

FIG. 5 shows an example of data structure of the apparatus-use packet table 405.

The apparatus-use packet table 405 is an example of the first condition information of the communication control apparatus 100 according to the present invention, and is a table which indicates equal to or greater than N conditions for use in identifying packets to be stored in the first memory 103. More specifically, the apparatus-use packet table 405 is a table in which the condition for use in identifying the packet required by the communication control apparatus 100 is stored.

The example shown in FIG. 5 represents the apparatus-use packet table 405 configured with N+1=4 entries. More specifically, in this embodiment, it is indicated that the number of the patterns of packets that the communication control apparatus 100 should receive for communication is 4. It is to be noted that the number of the patterns “4” is an example for clarifying the description of the embodiment, and the value is not limited to a specific number.

Each entry includes a “registration pattern”, a “registration order”, and a “registering flag”, as data items. Furthermore, each entry is assigned with an entry number.

The “registration pattern” is an item which indicates a packet pattern to be registered in the pass packet table 205. The “registration order” is an item which indicates the order which the packet pattern of the entry is registered in the pass packet table 205. The “registering flag” is an item for identifying whether or not the packet pattern of the entry is registered in the pass packet table 205.

It is to be noted that although the “pattern 1” etc. are shown in FIG. 5, information having the same data structure as shown in the “pattern” in the pass packet table 205 shown in FIG. 3 is registered as the “registration pattern”.

The “registration order” is an item which indicates a value to be counted up sequentially, and is a record of the order in which the update control unit 403 has registered the pattern of the entry in the pass packet table 205. For example, in the example shown in FIG. 5, it is indicated that the registration pattern with the entry number “1”, the registration pattern with the entry number “2”, and the registration pattern with the entry number “3” were registered in the pass packet table 205 in this order.

The “registering flag” is an item for use in identifying whether or not the registration pattern of the entry is registered in the pass packet table 205. More specifically, an entry registered in the pass packet table 205 is recorded as “registered”, and an entry not registered in the pass packet table 205 is recorded as “unregistered”.

The update control unit 403 is capable of searching for an entry to be updated next, based on the registration order and the registering flag which are indicated in the apparatus-use packet table 405.

That is, when a registering flag of an entry is “registered”, the smaller the value of the registration order is, the earlier the entry has been registered in the pass packet table 205. In other words, that is the entry which has been registered in the pass packet table 205 earliest. Accordingly, it is possible to determine that the packet pattern indicated in the entry is to be replaced preferentially.

Furthermore, when a registering flag of an entry is “unregistered”, the smaller the value of the registration order is, the longer the entry has been unregistered in the pass packet table 205. In other words, that is the entry which has been unregistered in the pass packet table 205 for the longest period after deletion. Accordingly, it is possible to determine that the packet pattern indicated in the entry is to be registered preferentially.

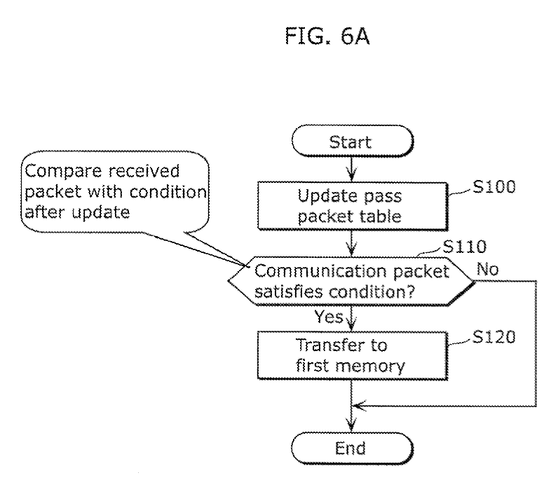

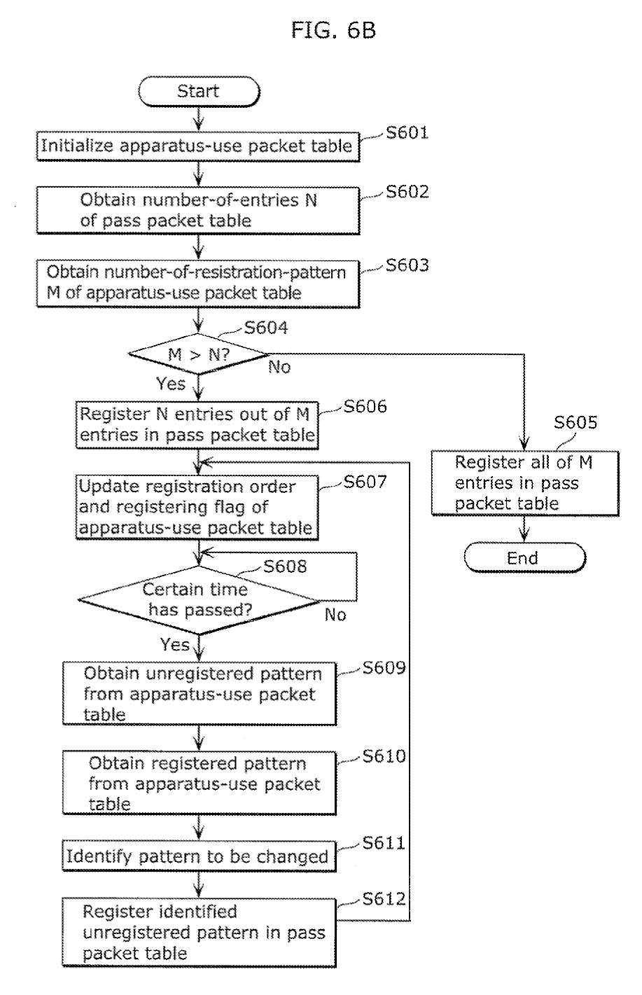

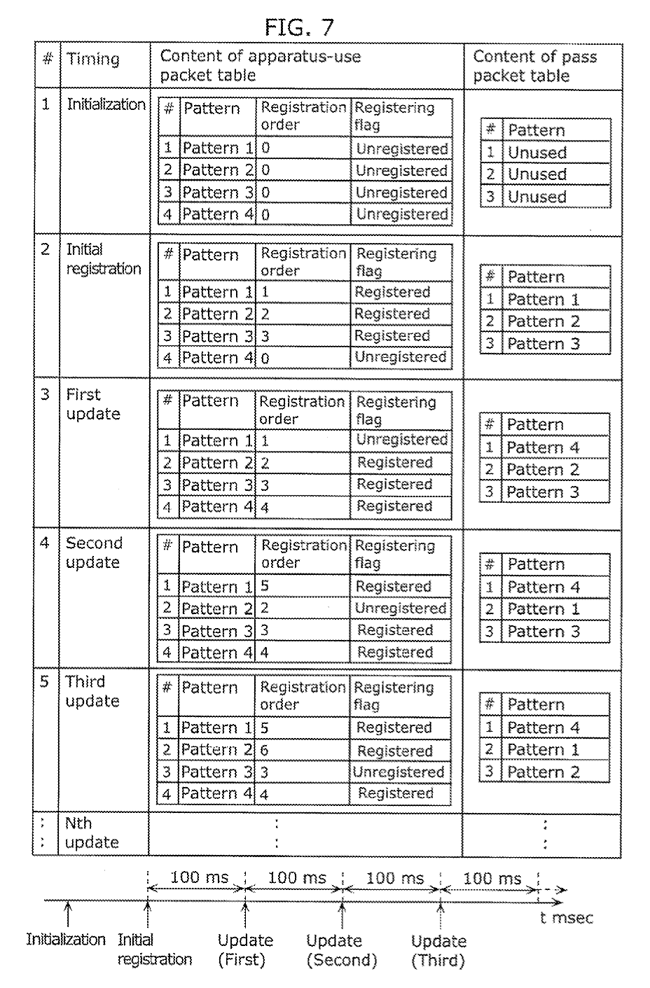

Next, the process flow of the communication control apparatus 100 according to the embodiment of the present invention configured as described above is descried with reference to FIG. 6A to FIG. 7.

First, a basic flow of the process of the communication control apparatus 100 is described with reference to FIG. 6A.

FIG. 6A is a flow chart showing the basic flow of the process performed by the communication control apparatus 100 according to the embodiment of the present invention.

The first control unit 206 updates the pass packet table 205 using information indicated in the apparatus-use packet table 405 (S100).

The second control unit 210 performs the filtering process of the packet received by the packet receiving unit 201, based on the condition registered in the pass packet table 205 after the update (S110). More specifically, the following process is performed by the comparing unit 202 and the transfer unit 204.

The comparing unit 202 compares the received packet with the packet pattern indicated in the pass packet table 205 after the update by the first control unit 206. Thus, it is determined whether or not the received packet satisfies the condition indicated in the pass packet table 205 after the update (S110).

When it is determined that the received packet satisfies the condition (Yes in S110), the received packet is transferred to, by the transfer unit 204, and stored in the first memory 103 (S120).

It is to be noted that when it is determined that the received packet does not satisfy the condition, in this embodiment, the received packet is discarded by the discarding unit 203.

Next, the detailed process flow for the update of the pass packet table 205 is described with reference to FIG. 6B.

FIG. 6B is a flow chart showing a flow of a set of the process of the control unit 206 when performing an update control.

The update control unit 403 included in the first control unit 206 initializes the apparatus-use packet table 405 at an initial period such is as when starting a communication program (S601). Since the pass packet table 205 is unused in the initial state, the update control unit 403 sets (i) the registration order of each entry in the apparatus-use packet table 405 to “0” and (ii) the registering flag to “unregistered”, via the table updating unit 402. Thus, the apparatus-use packet table 405 is initialized.

The update control unit 403 obtains the maximum number-of-the-entries N registerable in the pass packet table 205, via the entry number obtaining unit 401 (S602). Since the maximum number-of-the-entries registerable in the pass packet table 205 is 3 in this embodiment, the update control unit 403 obtains N=“3”.

The update control unit 403 obtains the number-of-the-entries M registered in the apparatus-use packet table 405 (S603). Since the apparatus-use packet table 405 is configured with 4 entries in this embodiment, the update control unit 403 obtains M=“4”.

The update control unit 403 determines whether or not the number-of-the-entries M registered in the apparatus-use packet table 405 is greater than the maximum number-of-the-entries N registerable in the pass packet table 205 (S604).

When the result of the determination in S604 is false (No in S604), the update control unit 403 determines that all of the entries registered in the apparatus-use packet table 405 are registerable in the pass packet table 205. As a result, the update control unit 403 registers packet patterns of all of the entries indicated in the apparatus-use packet table 405 in the pass packet table 205 (S605), and completes the process related to the update of the pass packet table 205.

When the result of the determination in S604 is true (Yes in S604), not all of the entries registered in the apparatus-use packet table 405 can be registered in the pass packet table 205.

Therefore, the update control unit 403 performs an update process to sequentially rewrite the content of the pass packet table 205. More specifically, the following process is performed.

The update control unit 403 registers N entries which are registerable in the pass packet table 205 out of the M entries registered in the apparatus-use packet table 405 (S606). The update control unit 403 extracts 3 entries that match, for example, the patterns 1 to 3, out of the 4 entries in the apparatus-use packet table 405. The update control unit 403 registers the 3 extracted packet patterns in the pass packet table 205 by controlling the table updating unit 402.

The update control unit 403 updates the registration order and the registering flag of the 3 entries in the apparatus-use packet table 405 which were determined to be registered in the process of S606 (S607). More specifically, the update control unit 403 assigns values from 1 to 3 in the order of the registration as the registration number of the 3 entries, and updates the registering flag to “registered”. Content in FIG. 5 is the apparatus-use packet table 405 as a result of the above process.

The update control unit 403 determines whether or not a certain period of time has passed (S608). More specifically, the update control unit 403 determines whether or not a notification is generated from the timer 404, and, when no notification is generated (No in S608), the process returns to S608 and waits until a notification is generated.

When the notification is generated from the timer 404 (Yes in S608), the update control unit 403 obtains an entry having an “unregistered” registering flag from the apparatus-use packet table 405 (S609). In this example, the update control unit 403 obtains an entry that matches the pattern 4 in the apparatus-use packet table 405.

The update control unit 403 further obtains a pattern of an entry having a “registered” registering flag from the apparatus-use packet table 405 (S610). More specifically, because the entries that match the patterns 1 to 3 in the apparatus-use packet table 405 are “registered”, the update control unit 403 further obtains these 3 entries.

The update control unit 403 identifies a pattern to be changed out of the entries obtained in S609 and S610 (S611).

More specifically, the update control unit 403 identifies an entry having the smallest value of the registration order out of the 3 entries obtained in S610. Here, the registration order of the entry of the pattern 1 is the smallest. Accordingly, the pattern 1 in the pass packet table 205 is identified as the pattern to be replaced with the pattern 4 obtained in S609.

The update control unit 403 controls the table updating unit 402 to register the unregistered pattern obtained in S609 in the pass packet table 205 (S612). More specifically, the table updating unit 402 replaces the content of the pattern 1 in the pass packet table 205 with the content of the pattern 4 indicated in the apparatus-use packet table 405.

The update control unit 403 returns to S607 and updates the registration order and the registering flag of the entries in the apparatus-use packet table 405. More specifically, the update control unit 403 updates the registering flag of the entry of the pattern 1 from “registered” to “unregistered”, and updates the registering flag of the pattern 4 from “unregistered” to “registered”. The update control unit 403 updates the registration order of each entry to an up-to-date value. That is, at this time, “4” is recorded in the apparatus-use packet table 405 as the registration order of the pattern 4.

FIG. 7 shows an example of transition of content of each table in the case where the process flow shown in FIG. 6B is performed.

It is to be noted that FIG. 7 is shown based on an assumption that the notification from the timer 404 is performed in every 100 ms.

As shown in FIG. 7, the 3 packet patterns of the patterns 1 to 3 are registered in the pass packet table 205 at the timing of an initial registration. Therefore, only the received packet that matches any one of the 3 packet patterns pass the network interface 102 and are transferred to and stored in the first memory 103. The received packet stored in the first memory 103 is processed by a communication program executed by the execution unit 207.

After that, at every periodical update to the pass packet table 205, a pattern registered in the pass packet table 205 earliest, out of the 3 patterns in the pass packet table 205, is replaced with a pattern not registered in the pass packet table 205 at the time of the update.

This makes it possible for the communication control apparatus 100 to allow only the received packet required by the apparatus to be passed the network interface 102 and stored in the first memory 103.

In other words, it is impossible for the attacking packet that does not match any one of the packet patterns indicated in the pass packet table 205 to pass the network interface 102, and thus the communication control apparatus 100 is protected from the DoS attack.

Here, a case is assumed that the number of the patterns registered in the apparatus-use packet table 405 exceeds, by equal to, or greater in than 2, the maximum number-of-the-entries N registerable in the pass packet table 205. In this case, at the time of a given update, there are plural packet patterns not registered in the pass packet table 205 (unregistered patterns) included in the packet patterns registered in the apparatus-use packet table 405.

In the case where there are plural unregistered patterns as described above, the first control unit 206 identifies, for example, an unregistered pattern which has been unregistered in the pass packet table 205 for the longest period after deletion out of the plural unregistered patterns. In short, the first control unit 206 identifies an unregistered pattern which has not been used for packet filtering for the longest period.

Furthermore, the first control unit 206 reads the identified unregistered pattern from the apparatus-use packet table 405, and replaces the unregistered pattern with a packet pattern which has been registered in the pass packet table 205 for the longest period.

Thus, each of the plural packet patterns registered in the apparatus-use packet table 405 is sequentially registered in the pass packet table 205 certainly and evenly.

It is to be noted that the comparison on each of the plural packet patterns regarding (i) the period for which the packet pattern has been unregistered in the pass packet table 205 after deletion and (ii) the period for which the packet pattern has been registered in the pass packet table 205 can be identified by comparing a value of the registration order of each packet pattern.

Furthermore, (i) the latest registering time in the pass packet table 205 of each of the plural packet patterns and (ii) the latest deleting time from the pass packet table 205 of each of the plural packet patterns may be recorded in the apparatus-use packet table 405 by, for example, the update control unit 403.

In this case, with reference to the times above, it is also possible to identify (i) an unregistered pattern to be registered in the pass packet table 205 at the next update and (ii) a pattern to be replaced with the unregistered pattern.

Furthermore, the update of the pass packet table 205 is not necessarily performed after the passage of a predetermined time (100 ms in the example shown in FIG. 7). That is, the update of the pass packet table 205 is not necessarily made at a regular time interval. It is sufficient for the pass packet table 205 to be repeatedly updated so that all the packet patterns required for packet filtering are indicated in the pass packet table 205.

As described above, the communication control apparatus 100 according to this embodiment has a packet filtering function. More specifically, the communication control apparatus 100 allows only the received packet which corresponds to the packet pattern registered in the pass packet table 205 to pass the network interface 102 as the packet to be processed by the communication program, and stores the packet in the first memory 103. Furthermore, the communication control apparatus 100 discards the received packet that does not match any one of these packet patterns as the DoS packet.

Furthermore, when the number of the patterns of the received packets to be passed the network interface 102 exceeds the maximum number of the patterns registerable in the pass packet table 205, the pass packet table 205 is updated so that a combination of the packet patterns held in the pass packet table 205 is switched by time sharing.

This allows to provide a communication control apparatus which receives received packets of types of equal to or greater than the maximum number of the patterns registerable in the pass packet table 205, as qualified packets, while avoiding a DoS packet.

It is to be noted that the update process of the pass packet table 205 shown in FIG. 7 is an example and the present invention is not limited to the process. For example, a case is assumed that the maximum number of the patterns registerable in the pass packet table 205 is 3 and the number of the patterns registered in the apparatus-use packet table 405 is equal to or greater than 5.

In this case, the update control unit 403 may concurrently replace equal to or greater than 2 patterns out of the 3 patterns registered in the pass packet table 205.

That is, it is sufficient for the pass packet table 205 to be updated so that each of the plural packet patterns corresponding to all types of the received packets essentially required is indicated in the pass packet table 205 at any one of the timings for the update which is performed repeatedly.

Furthermore, the priorities of the packet patterns registered in the apparatus-use packet table 405 may be determined with taking into consideration the frequency of start-up, a type of a process, or the like of a communication program which corresponds to each of the packet patterns.

For example, a packet pattern corresponding to a communication program which is always or most frequently activated, out of the as plural of communication programs performed by the communication control apparatus 100, can be a high-priority packet pattern.

A packet pattern corresponding to, for example, a communication program for receiving and outputting an emergency broadcast informing of disasters or the like can also be the high-priority packet pattern.

Furthermore, a packet pattern corresponding to, for example, a communication program for decoding and displaying stream data of a moving image (that is, a packet pattern for recognizing the stream data) can also be the high-priority packet pattern from a perspective of a smooth reproduction of a moving image.

Therefore, the pass packet table 205 may be updated so that such high-priority packet patterns are registered in the pass packet table 205 always or as long as possible.

In this case, for example, each entry in the apparatus-use packet table 405 shall be added to priority information (value etc.) indicating a priority determined according to the frequency of start-up of a communication program corresponding to each of the entries, a type of the process to be performed, or the like.

Furthermore, at the update of the pass packet, table 205, the first control unit 206 reads, from the apparatus-use packet table 405, the packet pattern with highest priority out of the plural packet patterns not registered in the pass packet table 205. Furthermore, the first control unit 206 replaces the read packet pattern with, for example, the packet pattern with lowest priority in the pass packet table 205.

Thus, the packet pattern with high priority is maintained to be registered in the pass packet table 205 longer than the packet pattern with low priority.

Furthermore, the apparatus-use packet table 405 which supplies packet patterns to the pass packet table 205 may be updated.

FIG. 8 shows an example of correspondence of communication programs and packet patterns, registered in the apparatus-use packet table.

As shown in FIG. 8, a case is assumed that the patterns 1 to 4 respectively correspond to the communication programs [A] to [D]. For example, a received packet corresponding to the pattern 1 is a packet to be processed by [A].

In this case, for example, the apparatus-use packet table 405 may be updated depending on the startup status of the communication program.

FIG. 9A shows a first example of the apparatus-use packet table 405 after the update, and FIG. 9B shows a second example of the apparatus-use packet table 405 after the update.

For example, a case is assumed that only [A] and [C], out of the communication programs [A] to [D], are activated. In this case, only the patterns 1 and 3 corresponding to [A] and [C] are registered in the apparatus-use packet table 405.

This registration process is performed by, for example, the update control unit 403 to register the patterns 1 and 3 in the apparatus-use packet table 405 according to a direction of each of [A] and [C] which are activated.

It is to be noted that information which indicate the patterns 1 and 3 may be held in [A] and [C], and stored, for example, in the HDD 105 separately from the apparatus-use packet table 405, as the packet patterns to be registered in the apparatus-use packet table 405.

After that, for example, when the communication program [B] is activated, the update control unit 403 registers the pattern corresponding to [B] in the apparatus-use packet table 405.

Furthermore, at this time, a single packet pattern can be added to the pass packet table 205. Accordingly, the pattern 2 is read from the apparatus-use packet table 405 and registered in the pass packet table 205.

It is to be noted that, after that, for example, when the communication program [A] is completed (that is, when the execution of [A] is finished and [A] has transited to an inactivated state), for example, the update control unit 403 deletes the pattern 1 from the apparatus-use packet table 405.

As described above, updating the apparatus-use packet table 405 depending on the startup status of each of the plural communication programs allows to maintain a state that only the packet pattern actually required for packet filtering is registered in the apparatus-use packet table 405.

As a result, only the packet pattern actually required is registered in the pass packet table 205 for use in comparison with the received packet. Thus, a more efficient packet filtering is performed.

For example, as described above, when 4 packet patterns are registered in the apparatus-use packet table 405 and the maximum number-of-the-entries N registerable in the pass packet table 205 is 3, not all of the 4 packet patterns can be held in the pass packet table 205. Therefore, the pass packet table 205 is updated in the manner as shown in FIG. 7. With this, each of the 4 packet patterns is intermittently indicated in the pass packet table 205.

However, as shown in FIG. 9A for example, when only the communication programs [A] and [C] are activated, the packet as patterns actually required for packet filtering are the patterns 1 and 3 only. In this case, these patterns 1 and 3 can be maintained to be always registered in the pass packet table 205.

Furthermore, for example, a case is assumed that the maximum number-of-the-entries N registerable in the pass packet table 205 is 3 and the total number of the packet patterns for use in packet filtering is 10. Under such an assumption, even when the startup status of each communication program is taken into consideration, an update of the pass packet table 205 is required when, for example, the number of the activated communication programs is 5.

However, the process will be performed more efficiently by sequentially registering, in the pass packet table 205 whose the maximum number-of-the-registerable-entries N is 3, each of the 5 packet patterns than each of the 10 packet patterns. More specifically, the former way allows the packet pattern actually required for packet filtering to be registered in the pass packet table 205 for a longer period.

It is to be noted that the pass packet table 205 may be updated depending on the startup status of the communication program, instead of updating the apparatus-use packet table 405.

For example, the first control unit 206 checks, before updating the pass packet table 205, which communication program is being activated. Furthermore, the first control unit 206 (i) reads, from the apparatus-use packet table 405, a packet pattern which corresponds to a communication program being activated and is not registered in the pass packet table 205 at the time of the update and (ii) registers the packet pattern in the pass packet table 205.

More specifically, the read unregistered pattern is replaced with a packet pattern corresponding to an inactivated communication program or the packet pattern which has been registered in the pass as packet table 205 for the longest period.

It is also possible to maintain only the packet pattern actually required for, packet filtering to be registered in the pass packet table 205, through the performance of such a process by the first control unit 206.

That is, when the total number of the packet patterns required for packet filtering exceeds the maximum number-of-the-entries N registerable in the pass packet table 205, it is possible to further improve the efficiency of the process related to packet filtering, regardless of the size of the difference in the number of N and the total number, by controlling (updating and maintaining without updating) the pass packet table 205 while taking into consideration, as necessary, which packet pattern is actually required at each time.

Furthermore, the network interface 102 is configured with hardware in this embodiment. That is, the communication control apparatus 100 performs packet filtering by hardware.

However, the communication control apparatus 100 may perform packet filtering by causing, for example, the CPU 104 to refer to the pass packet table 205 stored in a predetermined recording medium.

In this case, it is sufficient for the CPU 104 to compare the received packet with packet patterns less than the total number of the packet patterns required for packet filtering. This allows to perform a more efficient packet filtering than the case where all, packet patterns required for packet filtering are used for the comparison.

The communication control apparatus according to an aspect of the present invention has been described based on the embodiment. However, the present invention is not limited to the embodiment. Other forms in which various modifications apparent to those skilled in the art are applied to the embodiment, or forms structured by combining elements of different embodiments are included within the scope of the present invention, unless such changes and modifications depart from the scope of the present invention.

### INDUSTRIAL APPLICABILITY

As described above, according to the present invention, it is possible to efficiently use the limited memory capacity, thereby allowing a receiving packet required by the communication system without having the communication system destroyed by the DoS attack. Therefore, this invention is useful as a home appliance such as a TV and a communication apparatus which transmits and receives information, and as a communication control apparatus included in a communication apparatus and a home appliance.

### REFERENCE SIGNS LIST

100 Communication control apparatus
101 LAN
102 Network interface
103 First memory
104 CPU
105 HDD
200 Second memory
201 Packet receiving unit
202 Comparing unit
203 Discarding unit
204 Transfer unit
205 Pass packet table
206 First control unit
207 Execution unit
210 Second control unit
401 Entry number obtaining unit
402 Table updating unit
403 Update control unit
404 Timer
405 Apparatus-use packet table

1. A communication control apparatus which is connected to a network and executes one or more communication application programs,
said communication control apparatus comprising:
a first control unit;
a first memory for storing packets to be processed by the one or more communication application programs;
a storage unit in which first condition information is stored, the first condition information indicating N+1 or more conditions for identifying packets to be stored in said first memory, and N representing an integer equal to or greater than 1; and
a network communication unit configured to selectively transfer a received packet to said first memory,
wherein said network communication unit includes:
a receiving unit configured to receive a packet transmitted via the network;
a second memory for storing second condition information, the second condition information in which at most N conditions out of the N+1 or more conditions are registered; and
a second control unit configured to perform a filtering process that is a process to transfer, to said first memory, a packet that matches a condition registered in the second condition information out of packets received by said receiving unit, and
said first control unit is configured to update the second condition information using at least one of the N+1 or more conditions indicated in the first condition information.

2. The communication control apparatus according to claim 1,
wherein said first control unit is configured to, when updating the second condition information, (i) read, from the first condition information, an unregistered condition that is a condition not registered, at the time of the update, in the second condition information out of the N+1 or more conditions indicated in the first condition information, and (ii) register the unregistered condition in the second condition information by replacing the read unregistered condition with one of the conditions indicated in the second condition information.

3. The communication control apparatus according to claim 1,
wherein said first control unit is configured to repeatedly update the second condition information.

4. The communication control apparatus according to claim 1,
wherein said first control unit is configured to register, in the second condition information, each of the N+1 or more conditions in a predetermined order by repeatedly updating the second condition information, the N+1 or more conditions being indicated in the first condition information.

5. The communication control apparatus according to claim 2,
wherein said first control unit is configured to, when updating the second condition information and there is a plurality of unregistered conditions, identify an unregistered condition which has been unregistered in the second condition information for a longest period after deletion, out of the plurality of the unregistered conditions, and read the identified unregistered condition from the first condition information.

6. The communication control apparatus according to claim 2,
wherein the first condition information further includes priority information which indicates a priority of each of the conditions indicated in the first condition information, and
said first control unit is configured to, when updating the second condition information and there is a plurality of unregistered conditions, identify an unregistered condition with highest priority, out of the unregistered conditions with reference to the priority information, and read the identified unregistered condition from the first condition information.

7. The communication control apparatus according to claim 2,
wherein said first control unit is configured to, when updating the second condition information, identify a condition that has been registered in the second condition information earliest, out of the at most N conditions indicated in the second condition information, and replace the identified condition with the unregistered condition read from the first condition information by said first control unit.

8. A communication control apparatus according to claim 1,
wherein each of the N+1 or more conditions corresponds to one of the one or more communication application programs, and
said first control unit is further configured to, when one of the one or more communication application programs is executed, update the first condition information by adding, to the first condition information, a condition which corresponds to the communication application program to be executed.

9. The communication control apparatus according to claim 8,
wherein said first control unit is further configured to, when the execution of the communication application program is completed, delete the condition which corresponds to the communication application program from the first condition information.

10. A packet filtering method performed by a communication control apparatus which is connected to a network and executes one or more communication application programs,
wherein said communication control apparatus includes:
a first memory for storing packets to be processed by the one or more communication application programs;
a storage unit in which first condition information is stored, the first condition information indicating N+1 or more conditions for identifying packets to be stored in said first memory, and N representing an integer equal to or greater than 1; and
a network communication unit which selectively transfers a received packet to said first memory;
said packet filtering method comprising:
receiving a packet transmitted via the network using the network communication unit;
updating the second condition information stored in the second memory of the network communication unit using at least one of the N+1 or more conditions indicated in the first condition information, the second condition information in which N conditions out of the N+1 or more conditions are stored; and
performing filtering which is a process to transfer, to said first memory, a packet that matches a condition registered in the second condition information updated in said updating out of the packets received in said receiving.
